(19) United States
(12) Patent Application Publication
(10) Pub. No.: US 2019/0227303 A1
(43) Pub. Date: Jul. 25, 2019

(54) OPTICAL SCANNING APPARATUS AND METHOD FOR ASSEMBLING AND ADJUSTING OPTICAL SCANNING APPARATUS

(71) Applicant: OLYMPUS CORPORATION, Tokyo (JP)

(72) Inventor: Masato Fujiwara, Tokyo (JP)

(73) Assignee: OLYMPUS CORPORATION, Tokyo (JP)

(21) Appl. No.: 16/373,721

(22) Filed: Apr. 3, 2019

Related U.S. Application Data
(63) Continuation of application No. PCT/JP2016/084423, filed on Nov. 21, 2016.

(51) Int. Cl. G02B 26/10; G02B 23/24

(52) U.S. Cl. CPC G02B 26/103; G02B 23/2469

(57) ABSTRACT

An optical scanning apparatus includes: an optical fiber that is configured to emit light from a distal end portion towards a subject; and a driving device that, when an AC signal having a driving frequency in proximity to an nth-order resonance frequency Fₙ of a vibrator including the distal end portion and a member vibrating integrally with the distal end portion is applied, generates a driving force for vibrating the distal end portion of the optical fiber in a plane orthogonal to a longitudinal direction of the optical fiber. The absolute value of the difference between the nth-order resonance frequency Fₙ and a neighboring (n±1)th-order resonance frequency F_{n±1} of the vibrator is 0.25×Fₙ or less.

### CROSS-REFERENCE TO RELATED APPLICATIONS

This is a continuation of International Application PCT/JP2016/084423, with an international filing date of Nov. 21, 2016, which is hereby incorporated by reference herein in its entirety.

### TECHNICAL FIELD

The present invention relates to an optical scanning apparatus and a method for assembling and adjusting an optical scanning apparatus.

### BACKGROUND ART

There are well-known endoscopes provided with an optical scanning apparatus for scanning illumination light on a subject by emitting illumination light towards the subject from distal end of a vibrating optical fiber (refer to, for example, Patent Literature 1). As means for vibrating the distal end of such an optical fiber, a method for vibrating the distal end of the optical fiber using vibration generated by piezoelectric elements is used.

The larger the amplitude of the optical fiber, the larger the irradiation area of illumination light, i.e., the examination area, and furthermore the higher the definition of an acquired image. Thus, the amplitude of the optical fiber is preferably larger. In general, methods for increasing the amplitude of an optical fiber include a method for increasing energy input to a driving device and a method for bringing the driving frequency for vibration-driving the optical fiber close to the resonance frequency of the optical fiber.

### CITATION LIST

### Patent Literature

### {PTL 1}

Japanese Unexamined Patent Application, Publication No. 2014-145941

### SUMMARY OF INVENTION

A first aspect of the present invention is an optical scanning apparatus comprising: an optical fiber that is configured to emit light from a distal end portion towards a subject; and a driving device that, when an AC signal having a driving frequency in proximity to an nth-order resonance frequency Fₙ of a vibrator including the distal end portion and a member vibrating integrally with the distal end portion is applied thereto, generates a driving force for vibrating the distal end portion of the optical fiber in a plane orthogonal to a longitudinal direction of the optical fiber, wherein the difference between the nth-order resonance frequency Fₙ and a neighboring (n±1)th-order resonance frequency F_{n±1} of the vibrator satisfies the following formula (1):

|F_{n±1}−Fₙ|≤0.25Fₙ (1).

A second aspect of the present invention is a method for assembling and adjusting an optical scanning apparatus including: an optical fiber for emitting illumination light from a distal end portion towards a subject; and a driving device that, when an AC signal having a driving frequency in proximity to an nth-order resonance frequency Fₙ of a vibrator including the distal end portion and a member vibrating integrally with the distal end portion is applied thereto, generates a driving force for vibrating the distal end portion of the optical fiber in a plane orthogonal to a longitudinal direction of the optical fiber, the method comprising: an assembly step of assembling the optical fiber and the driving device, wherein a structure parameter for governing a resonance frequency of the vibrator is adjusted such that the difference between the nth-order resonance frequency Fₙ and a neighboring (n±1)th-order resonance frequency F_{n±1} of the vibrator satisfies the following formula (1):

|F_{n±1}−Fₙ|≤0.25Fₙ (1)

### BRIEF DESCRIPTION OF DRAWINGS

FIG. 1 is an overall configuration diagram of an optical scanning endoscope system according to one embodiment of the present invention.

FIG. 2 is a longitudinal sectional view of a distal end portion of an insertion section of an endoscope in the optical scanning endoscope system in FIG. 1 and a diagram depicting the configuration of an optical scanning apparatus according to one embodiment of the present invention.

FIG. 2B is a front elevational view of the optical scanning apparatus in FIG. 2A as viewed from a distal end side thereof.

FIG. 3 is a diagram for illustrating a range of proximity to an nth-order resonance frequency.

FIG. 4A is a diagram for illustrating one example of the relationship between: the difference between the nth-order resonance frequency and the (n+1)-order resonance frequency; and the amplitude of vibration of an optical fiber at the nth-order resonance frequency.

FIG. 4B is a diagram for illustrating another example of the relationship between: the difference between the nth-order resonance frequency and the (n+1)-order resonance frequency; and the amplitude of vibration of the optical fiber at the nth-order resonance frequency.

FIG. 5 is a diagram for illustrating the relationship between the driving frequency and the amplitude of vibration of the optical fiber when an optical fiber with a Q value of 100 is used.

FIG. 6 is a diagram depicting a simulation result of the relationship between: the protruding length of the optical fiber; and the first-order and second-order resonance frequencies in a first embodiment of the present invention.

FIG. 7 is a diagram depicting a simulation result of the relationship between the protruding length of the optical fiber and the amplitude of vibration of the optical fiber in the first embodiment of the present invention.

FIG. 8 is a diagram depicting an experimental result of the relationship between: the protruding length of the optical fiber; and the first-order and second-order resonance frequencies in the first embodiment of the present invention.

FIG. 9 is a diagram depicting an experimental result of the relationship between the protruding length of the optical fiber and the amplitude of vibration of the optical fiber in the first embodiment of the present invention.

FIG. 10 is a diagram depicting a simulation result of the relationship between the optical fiber diameter and the amplitude of vibration of the optical fiber in a second embodiment of the present invention.

FIG. 11 is a diagram depicting a simulation result of the relationship between: the optical fiber diameter; and the first-order and second-order resonance frequencies in the second embodiment of the present invention.

FIG. 12 is a diagram depicting a simulation result of the relationship between: the ferrule length and the lengths of the piezoelectric elements; and the amplitude of vibration of the optical fiber in a third embodiment of the present invention.

FIG. 13 is a diagram depicting a simulation result of the relationship between: the ferrule length and the lengths of the piezoelectric elements; and the first-order and second-order resonance frequencies in the third embodiment of the present invention.

### DESCRIPTION OF EMBODIMENTS

An optical scanning apparatus 1 according to one embodiment of the present invention and an optical scanning endoscope system 100 provided with the same will now be described with reference to the drawings.

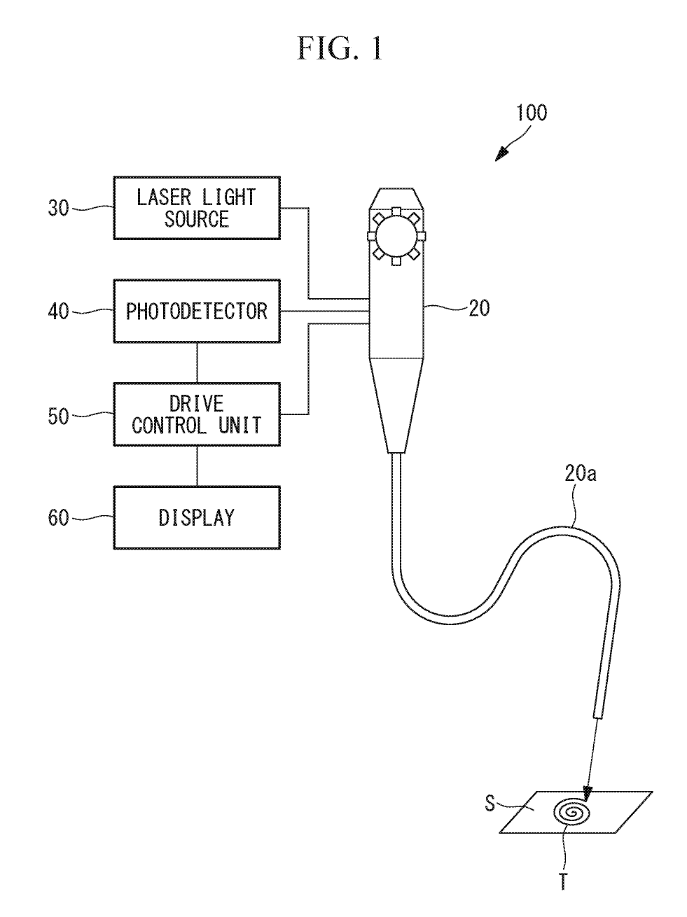

As shown in FIG. 1, the optical scanning endoscope system 100 according to this embodiment includes: an endoscope 20 having an elongated insertion section 20a; a laser light source 30, a photodetector 40, and a drive control unit 50 that are connected to the endoscope 20; and a display 60 connected to the drive control unit 50. The optical scanning endoscope system 100 scans, along a spiral scanning trajectory T on a subject S, illumination light emitted from a distal end of the insertion section 20a of the endoscope 20, thereby acquiring an image of the subject S.

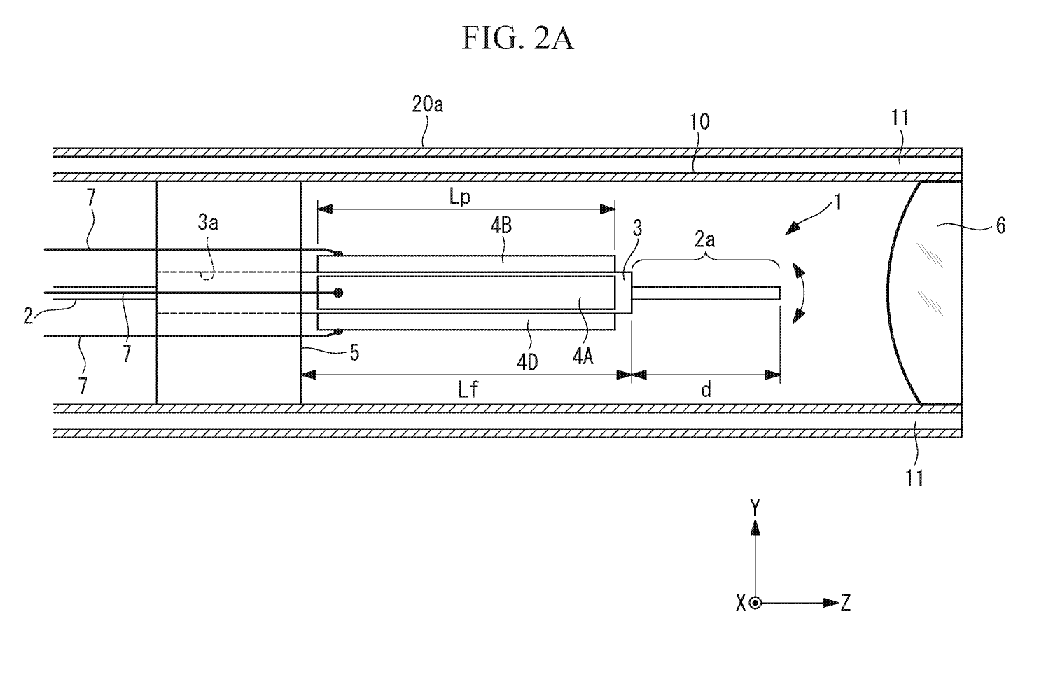

FIG. 2A shows the configuration of the optical scanning apparatus 1 provided at a distal end portion of the insertion section 20a. As shown in FIG. 2A, the endoscope 20 includes: an elongated cylindrical frame body 10 provided in the insertion section 20a along the longitudinal direction; the optical scanning apparatus 1 provided in the frame body 10; and a detecting optical fiber 11 that is provided on the outer circumferential surface of the frame body 10 and that receives return light (e.g., reflected illumination light or fluorescence) from the subject S.

As shown in FIGS. 2A and 2B, the optical scanning apparatus 1 includes: a lighting optical fiber 2; a cylindrical ferrule 3 for supporting the optical fiber 2; and a plurality of piezoelectric elements (driving devices) 4A, 4B, 4C, and 4D fixed to the outer circumferential surface of the ferrule 3.

The optical fiber 2 is a multimode fiber or a single-mode fiber formed of quartz and is in the shape of a column having a longitudinal axis. The optical fiber 2 is disposed in the frame body 10 along the longitudinal direction, and the distal end of the optical fiber 2 is disposed at the distal end portion in the frame body 10. The basal end of the optical fiber 2 is connected to the laser light source 30, and illumination light supplied from the laser light source 30 to the optical fiber 2 is emitted from the distal end of the optical fiber 2. Reference sign 6 is a focusing lens for focusing illumination light emitted from the optical fiber 2. Hereinafter, the longitudinal direction of the optical fiber 2 is defined as a Z direction, and two radial directions of the optical fiber 2 orthogonal to each other are defined as an X direction and a Y direction.

The ferrule 3 is formed of a metal having elasticity (e.g., nickel or copper) and is formed of a rectangular cylindrical member having a through-hole 3a penetrating therethrough along the central axis. The optical fiber 2 is inserted into the through-hole 3a, and the ferrule 3 is attached to a position separated from the distal end towards the basal end of the optical fiber 2 in the Z direction. The inner circumferential surface of the through-hole 3a and the outer circumferential surface of the optical fiber 2 are fixed with an adhesive. Hereinafter, the distal end portion of the optical fiber 2 protruding in the Z direction from the distal end surface of the ferrule 3 is referred to as a protruding section 2a.

A fixing part 5 for fixing the optical scanning apparatus 1 to the frame body 10 is provided on the basal end portion of the ferrule 3. The fixing part 5 is a circular cylindrical member having external dimensions that are larger than those of the ferrule 3, and the basal end portion of the ferrule 3 is inserted in the fixing part 5. The inner circumferential surface of the fixing part 5 is fixed to the basal end portion of the ferrule 3, and the outer circumferential surface of the fixing part 5 is fixed to the inner wall of the frame body 10. By doing so, each of the ferrule 3 and the protruding section 2a is supported by the fixing part 5 in the form of a cantilever where the distal end is a free end.

The piezoelectric elements 4A, 4B, 4C, and 4D are in the shape of a rectangular flat plate formed of a piezoelectric ceramic material such as lead zirconate titanate (PZT). In the piezoelectric elements 4A, 4B, 4C, and 4D, electrode processing is applied to two end surfaces opposed to each other in the thickness direction so as to polarize in the thickness direction. The two piezoelectric elements 4A and 4C for phase A are fixed with an adhesive to two respective side surfaces of the ferrule 3 opposed to each other in the X direction so that the polarization directions are parallel to the X direction and are oriented towards the same side. The two piezoelectric elements 4B and 4D for phase B are fixed with an adhesive to two respective side surfaces of the ferrule 3 opposed to each other in the Y direction so that the polarization directions are parallel to the Y direction and are oriented towards the same side.

The piezoelectric elements 4A, 4B, 4C, and 4D are connected to the drive control unit 50 via lead wires 7, and an AC voltage (AC signal) is applied from the drive control unit 50.

When an AC voltage for phase A is applied to the piezoelectric elements 4A and 4C for phase A, one of the piezoelectric elements 4A and 4C contracts in the Z direction and the other extends in the Z direction, thereby producing an X-direction bending vibration in the ferrule 3 with a node at the position of the fixing part 5. Then, as a result of the bending vibration of the ferrule 3 being transmitted to the protruding section 2a, the protruding section 2a undergoes a bending-vibration in the X direction at a frequency equal to the driving frequency of the AC voltage, thereby vibrating the distal end of the optical fiber 2 in the X direction. By doing so, the illumination light emitted from the distal end is scanned in the X direction.

When an AC voltage for phase B is applied to the piezoelectric elements 4B and 4D for phase B, one of the piezoelectric elements 4B and 4D contracts in the Z direction and the other extends in the Z direction, thereby producing a Y-direction bending vibration in the ferrule 3 with a node at the position of the fixing part 5. Then, as a result of the bending vibration of the ferrule 3 being transmitted to the protruding section 2a, the protruding section 2a undergoes a bending-vibration in the Y direction at a frequency equal to the driving frequency of the AC voltage, thereby vibrating the distal end of the optical fiber 2 in the Y direction. By doing so, the illumination light emitted from the distal end is scanned in the Y direction.

The AC voltage for phase A and the AC voltage for phase B have driving frequencies identical to each other and phases that differ by π/2 from each other, and the amplitudes thereof are temporally modulated in the shape of a sine wave. By doing so, the distal end of the optical fiber 2 vibrates along a spiral trajectory, and illumination light is scanned along the spiral scanning trajectory T.

Here, the relationship between the resonance frequencies of a vibrator including the protruding section 2a and the driving frequency of an AC voltage will be described.

When an AC voltage is applied to the piezoelectric elements 4A, 4B, 4C, and 4D, the protruding section 2a, the ferrule 3 for supporting the protruding section 2a, and the piezoelectric elements 4A, 4B, 4C, and 4D are integrally vibrated. The vibrator, composed of the protruding section 2a, the ferrule 3, and the piezoelectric elements 4A, 4B, 4C, and 4D, has resonance frequencies of first-order, second-order, third-order, . . . in ascending order of frequency. The resonance frequency of each order is determined by the structures of the protruding section 2a, the ferrule 3, and the piezoelectric elements 4A, 4B, 4C, and 4D. More specifically, structure parameters for governing the resonance frequencies of the vibrator include: the diameter (diameter) φ of the optical fiber 2; the Z-direction length (protruding length) d of the protruding section 2a; the X-direction and Y-direction widths Wf of the ferrule 3 and the Z-direction length Lf of the part protruding towards the distal end side from the fixing part 5; the widths Wp, the Z-direction lengths Lp, and the thicknesses Tp of the piezoelectric elements 4A, 4B, 4C, and 4D; and the densities of the optical fiber 2, the ferrule 3, and the piezoelectric elements 4A, 4B, 4C, and 4D.

The driving frequency is set to a frequency in proximity to the resonance frequency of any one order (nth-order) of the vibrator.

At least one of the above-described structure parameters is designed so that the nth-order resonance frequency Fₙ of the vibrator and the (n+1)th-order or (n−1)th-order resonance frequency F_{n±1} neighboring this nth-order resonance frequency Fₙ in the frequency direction satisfy formula (1) below.

|F_{n±1}−Fₙ|≤0.25Fₙ (1)

In other words, at least one of the above-described structure parameters is designed so that the (n±1)th-order resonance frequency comes close to the nth-order resonance frequency. Here, the difference |F_{n±1}−Fₙ| is preferably adjusted so as to become 3 kHz or less and is more preferably adjusted so as to become the smallest.

The driving frequency is more preferably set to a frequency in proximity to the third-order or lower resonance frequency of the vibrator. In this case, a structure parameter is designed so that the difference in resonance frequency between the first-order and the second-order, the second-order and the third-order, or the third-order and the fourth-order satisfies conditional formula (1). By vibrating the vibrator with the resonance of a lower-order resonance frequency, the protruding section 2a can be vibrated with a larger amplitude.

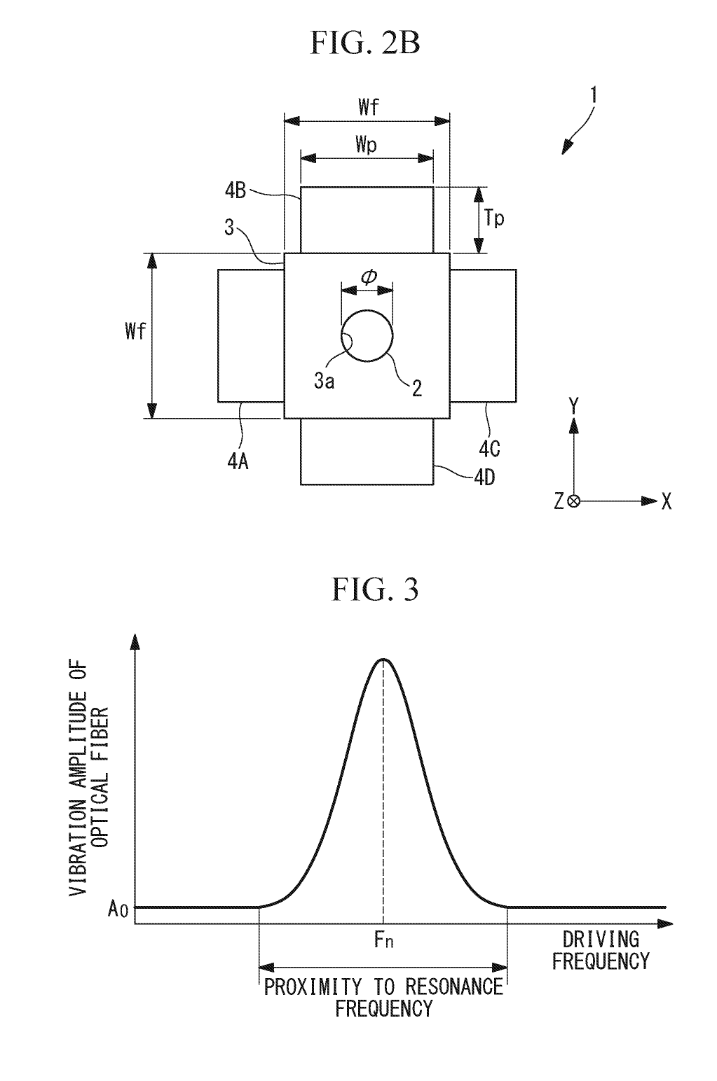

In this embodiment, a proximity to an nth-order resonance frequency means the range within which the amplitude of the distal end of the optical fiber 2 increases beyond an amplitude A₀ due to the resonance effect when the driving frequency of an AC voltage to be applied to the piezoelectric elements 4A, 4B, 4C, and 4D is swept from zero towards the high frequency side as shown in FIG. 3. When the driving frequency is zero, the amplitude of the distal end of the optical fiber 2 is a certain value A₀, and even when the driving frequency is increased, the amplitude remains as A₀ as long as the driving frequency is in a low frequency region. When the driving frequency comes close to the resonance frequency Fₙ the amplitude increases beyond A₀ due to the resonance effect, and when the driving frequency coincides with the resonance frequency, the amplitude exhibits a peak. When the driving frequency is further increased, the amplitude progressively decreases back to A₀.

The detecting optical fiber 11 extends from the distal end of the insertion section 20a to the photodetector 40. Return light generated by the subject S irradiated with illumination light is received by the optical fiber 11, is guided to the photodetector 40 via the optical fiber 11, and is detected by the photodetector 40. In order to increase the amount of received return light, a plurality of the optical fibers 11 may be provided on the frame body 10 in a row in the circumferential direction, and the photodetector 40 may detect the return light received by the plurality of optical fibers 11.

Information about the intensity of the returned light detected by the photodetector 40 is transmitted to the drive control unit 50. The drive control unit 50 calculates the irradiation position of the illumination light on the scanning trajectory T on the basis of the time-domain amplitude of the AC voltage applied to the piezoelectric elements 4A, 4B, 4C, and 4D and associates the intensity value of returned light with the irradiation position of the illumination light, thereby forming a two-dimensional image of the subject S. The two-dimensional image, which has been formed, is transmitted to the display 60 and is displayed on the display 60.

Next, the operation of the optical scanning apparatus 1 and the optical scanning endoscope system 100 with this configuration will be described.

In order to observe the subject S with the optical scanning endoscope system 100 according to this embodiment, supply of an AC voltage from the drive control unit 50 to the piezoelectric elements 4A, 4B, 4C, and 4D and supply of illumination light from the laser light source 30 to the optical fiber 2 are started. By doing so, each of the piezoelectric elements 4A, 4B, 4C, and 4D generates stretching vibration (driving force) to vibrate the distal end of the optical fiber 2 in a spiral form, thus scanning, in a spiral form, the illumination light emitted from the distal end towards the subject S. Return light from the subject S is received by the optical fiber 11 and is detected by the photodetector 40. As a result of the intensity of the detected returned light being associated with the position of illumination light on the scanning trajectory T in the drive control unit 50, an image of the subject S is generated, and the image is displayed on the display 60.

In this case, according to this embodiment, the amplitude of the vibrator increases due to the resonance effect by vibrating the vibrator at a frequency in proximity to the nth-order resonance frequency Fₙ of the vibrator. Furthermore, as a result of the (n±1)th-order resonance frequency F_{n±1} being close to the nth-order resonance frequency Fₙ of the vibrator, an even greater resonance effect can be obtained. By doing so, there is an advantage in that the amplitude of the protruding section 2a can be effectively increased without increasing the magnitude (amplitude) of the AC voltage. In particular, in a case where the (n±1)th-order resonance frequency F_{n±1} is closest to the nth-order resonance frequency Fₙ, the amplitude of the protruding section 2a at the driving frequency can be maximized.

The reason why the amplitude of the vibrator of the optical fiber 2 increases in a structure where the two resonance frequencies Fₙ and F_{n±1} neighboring in the frequency direction come close is as follows.

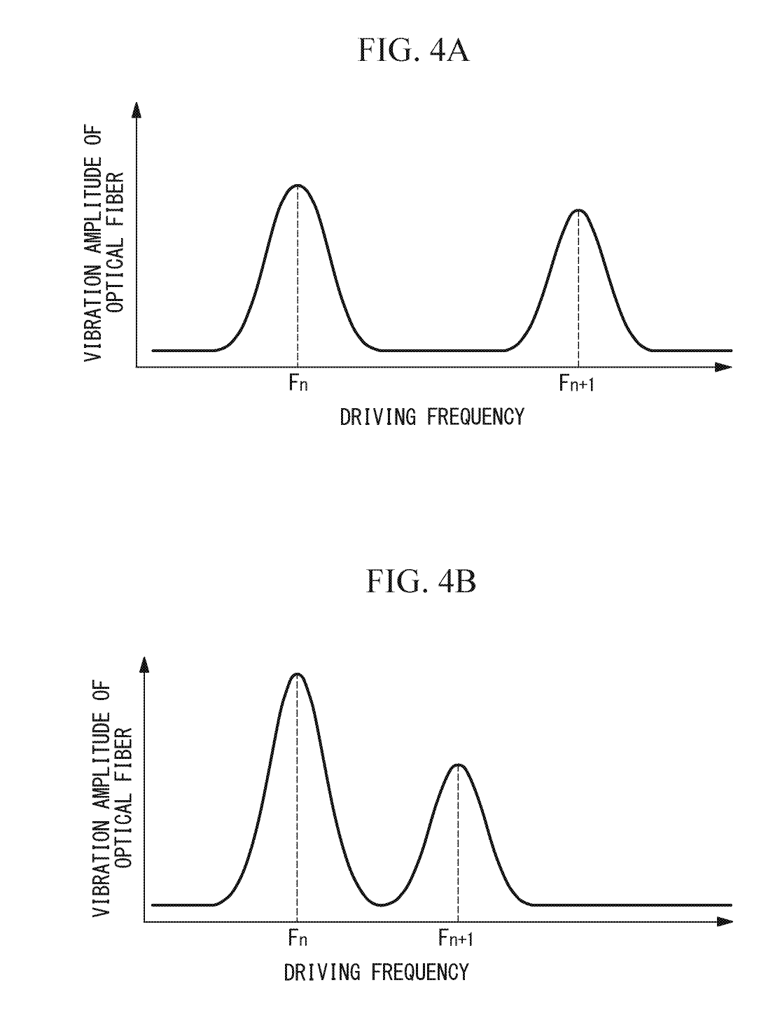

As described above, the resonance frequency of each order of the vibrator is determined depending on the structures of the protruding section 2a, the ferrule 3, and the piezoelectric elements 4A, 4B, 4C, and 4D. As shown in FIGS. 4A and 4B, when these structures are changed, the two neighboring resonance frequencies Fₙ and Fₙ₊₁ are made close to, or away from, each other, also causing a change in the amplitude of the vibrator when it is vibrated at each of the resonance frequencies Fₙ and Fₙ₊₁ FIGS. 4A and 4B represent the resonance frequencies Fₙ and Fₙ₊₁ of vibrators having different structures from each other.

Here, the amplitude of vibration when the vibrator is vibrated at the nth-order resonance frequency Fₙ or in proximity thereto becomes larger as the (n+1)th-order resonance frequency Fₙ₊₁ is closer to the nth-order resonance frequency Fₙ. This is probably because the (n+1)th-order resonant mode is excited in addition to the nth-order resonant mode, thus generating the resonance effect in a duplicated manner. As a result, the amplitude of vibration of the vibrator, including the protruding section 2a, can be increased significantly at a frequency in proximity to the two resonance frequencies Fₙ and Fₙ₊₁ close to each other, without increasing an AC voltage.

In particular, when the difference |F_{n±1}−Fₙ| is 3 kHz or less, a prominent duplicated resonance effect is achieved, thereby effectively increasing the amplitude of vibration of the protruding section 2a. Furthermore, when the difference |F_{n±1}-Fₙ| is minimized by bringing the (n+1)th-order resonance frequency Fₙ₊₁ closest to the nth-order resonance frequency Fₙ, the effect of increasing the amplitude is maximized, making it possible to maximize the amplitude of vibration of the protruding section 2a.

Furthermore, the larger the amplitude of vibration of the distal end of the optical fiber 2, the larger the number of image pixels, leading to a higher image definition. In particular, when the difference between the nth-order and (n±1)th-order resonance frequencies, |F_{n±1}−Fₙ|, satisfies conditional formula (1), a high-definition image can be acquired.

Conditional formula (1) specifies the range of the difference |F_{n±1}−Fₙ| in which the duplicated resonance effect can be achieved on the basis of experimental results and simulation results when the vibrator is vibrated at the nth-order resonance frequency Fₙ. More specifically, conditional formula (1) specifies the range of the difference |F_{n±1}−Fₙ| in which the amplitude of the distal end of the optical fiber 2 is 500 μm or more when an AC voltage having a typical maximum amplitude (e.g., 45 V) is applied. When the amplitude of the distal end of the optical fiber 2 is 500 μm or more at the resonance frequency Fₙ, a sufficiently high-definition two-dimensional image can be acquired.

Note that the range of conditional formula (1) is derived as follows.

Because the vibration of the vibrator becomes unstable when the driving frequency coincides with the nth-order resonance frequency Fₙ, the driving frequency needs to be made different from the nth-order resonance frequency Fₙ. Furthermore, side bands that appear on the low frequency side and on the high frequency side of the driving frequency due to amplitude modulation of the driving frequency also need to be made different from the resonance frequency Fₙ. Therefore, in order to vibrate the vibrator stably, at least 100 Hz is secured for the difference between the driving frequency and the resonance frequency Fₙ, and by taking the side bands into account, 30 Hz is further secured. Therefore, the driving frequency is set to the nth-order resonance frequency Fₙ±130 Hz.

Here, the Q value of the optical fiber 2 will be discussed. The Q value is an amplitude-increasing coefficient indicating approximately how much the amplitude increases when the driving frequency is brought close to a resonance frequency F₀, and is defined by the following formula. In the following formula, F₁ and F₂ are the frequencies, on the low frequency side and the high frequency side, respectively, of the resonance frequency F₀, at which the amplitude becomes 1/√2 times the maximum amplitude Aₚ (μm) at the resonance frequency F₀. The larger the Q value, the larger the amplitude achieved at the resonance frequency F₀.

Q=F₀/(F₂−F₁)

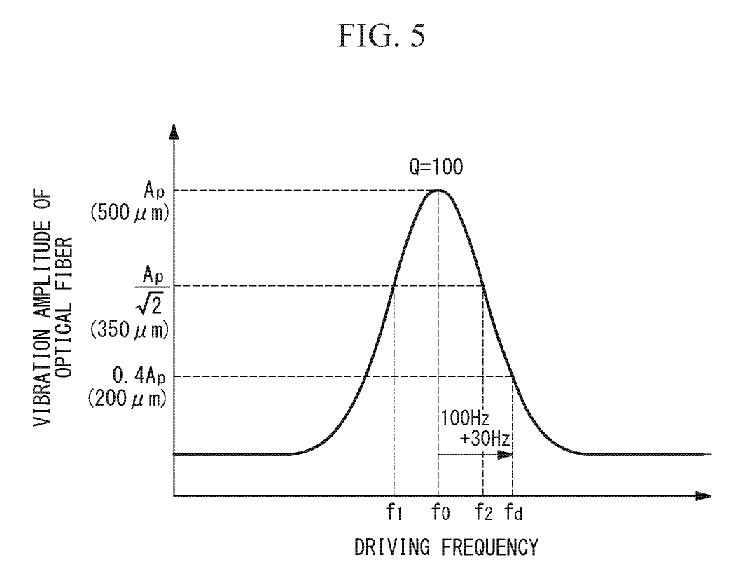

In the optical scanning apparatus 1 according to this embodiment, use of the optical fiber 2 with a Q value of about 100 is assumed, and hence, a case in which the Q value is 100 is discussed. As shown in FIG. 5, the amplitude of the distal end of the optical fiber 2 at a driving frequency f_{d} shifted by 130 Hz from the resonance frequency F₀ is about 0.4Aₚ. Therefore, the vibration of the distal end of the optical fiber 2 ranges within ±0.4Aₚ. On the other hand, the mode field diameter of a single-mode fiber used in the visible range is generally 3.5 μm. Therefore, the number of pixels of illumination light in one scanning line in the X direction or Y direction is represented as 2×0.4Aₚ/3.5, and is (2×0.4Aₚ/3.5)\hat{ }2 in terms of the number of pixels on a two-dimensional image. This indicates that the larger the amplitude of the distal end of the optical fiber 2, the larger the number of two-dimensional image pixels.

For medical use, for example, a two-dimensional image having a number of pixels of 13000 pixels or more is considered to have a high definition. From the description above, a high-definition image can be acquired by setting the maximum amplitude Aₚ of the protruding section 2a at the nth-order resonance frequency Fₙ to be 500 μm or more (the amplitude at the driving frequency f_{d} is about 200 μm).

Note that the scanning area (i.e., angle of field) of illumination light on the subject S can also be enlarged by increasing the projection magnification of the focusing lens 6, instead of increasing the amplitude of the distal end of the optical fiber 2. Note, however, that as the projection magnification of the focusing lens 6 becomes larger, the spot diameter of illumination light projected on the subject S also becomes larger, and hence the image resolution decreases. Therefore, in order to acquire a high-definition image, it is preferable that the angle of field be enlarged by increasing the amplitude of the distal end of the optical fiber 2, instead of drawing on the magnification of the optical system.

Next, a method for assembling and adjusting the optical scanning apparatus 1 will be described.

The method for assembling and adjusting the optical scanning apparatus 1 according to this embodiment includes, in an assembly step in which the optical fiber 2, the ferrule 3, and the piezoelectric elements 4A, 4B, 4C, and 4D are assembled: an adjustment step of measuring the nth-order and (n±1)th-order resonance frequencies Fₙ and F_{n±1} of the vibrator and adjusting the protruding length d on the basis of the difference between the resonance frequencies Fₙ and F_{n±1}.

The optical fiber 2 and the ferrule 3 are bonded to each other with an adhesive. Therefore, the adjustment step is performed after the optical fiber 2 is inserted in the through-hole 3a of the ferrule 3 and before the adhesive is cured. In the adjustment step, the nth-order and (n±1)th-order resonance frequencies Fₙ and F_{n±1} of the vibrator are measured while the protruding length d is being changed, a protruding length that causes the difference |F_{n±1}−Fₙ| to be 0.25Fₙ or less or preferably causes the difference |F_{n±1}−Fₙ| to be minimized is identified, and the ferrule 3 is positioned relative to the optical fiber 2 so that the protruding length d of the optical fiber 2 is the identified protruding length. Thereafter, the adhesive is cured.

In this manner, the adjustment of the protruding length d requires no members to be processed and is performed merely though adjustment of the relative position between the optical fiber 2 and the ferrule 3. Therefore, optimization of the resonance frequencies Fₙ and F_{n±1} can be easily performed.

An impedance analyzer is suitability used for measurement of the resonance frequencies Fₙ and Fₙ₊₁. Because an impedance analyzer can measure impedance by applying a very small voltage to the piezoelectric elements 4A, 4B, 4C, and 4D, only small vibration of the optical fiber 2 at the time of measurement is sufficient. Therefore, even if the adhesive is not cured, the error in measurement is small, and the resonance frequency of the vibrator can be accurately measured.

Other methods for adjusting the protruding length d so that the amplitude is maximized include a method for measuring the amplitude when the protruding section 2a is actually vibrated by applying a voltage to the piezoelectric elements 4A, 4B, 4C, and 4D. However, when the protruding section 2a is greatly vibrated before the adhesive is cured, a position shift of the ferrule 3 and the optical fiber 2 occurs, and the protruding length d changes, making it difficult to accurately measure the amplitude. When the amplitude of the protruding section 2a is suppressed to a small value to prevent a position shift of the ferrule 3 and the optical fiber 2, accurate measurement of the amplitude is difficult.

In the adjustment step, a structure parameter other than the protruding length d may be adjusted.

Adjustment of the length Lf of the ferrule 3 is performed merely by adjusting the relative position between the ferrule 3 and the fixing part 5 and requires no members to be processed in the same manner as in the adjustment of the protruding length d. Therefore, optimization of the resonance frequencies Fₙ and F_{n±1} can be performed easily.

Alternatively, in the adjustment step, the structure parameters φ, Wf, Wp, Lp, and Tp may be adjusted by applying processing, such as cutting, to the optical fiber 2, the ferrule 3, and the piezoelectric elements 4A, 4B, 4C, and 4D.

In addition, the number of structure parameters for adjusting the resonance frequencies Fₙ and F_{n±1} may be only one or may be multiple. For example, a combination of a plurality of structure parameters that bring the first-order resonance frequency and the second-order resonance frequency closest to each other may be employed by measuring the first-order and second-order resonance frequency when the plurality of structure parameters are simultaneously changed.

Next, Examples 1 to 3 of the optical scanning apparatus 1 according to this embodiment will be described.

Table 1 shows design values and values of conditional formula (1) for an optical scanning apparatus according to Examples 1 to 3.

TABLE 1

| | Example 1 | Example 2 | Example 3 |
|---|---|---|---|
| Optical fiber | 0.03 | 0.03 | 0.03 |
| diameter φ (mm) | | (adjusted) | |
| Optical fiber protruding | 1.40 | 1.40 | 1.40 |
| length d (mm) | (adjusted) | | |
| Ferrule length Lf (mm) | 2.80 | 2.80 | 2.5 |
| | | | (adjusted) |
| Piezoelectric element | 2.60 | 2.60 | 2.3 |
| length Lp (mm) | | | (adjusted) |
| F₂ − F₁ (kHz) | 2.06 | 1.86 | 1.80 |
| 0.25 × F₁ (kHz) | 2.88 | 2.93 | 2.77 |

### Example 1

In the optical scanning apparatus according to Example 1, the protruding length d was designed so that the difference between the first-order resonance frequency and the second-order resonance frequency of the vibrator became minimum.

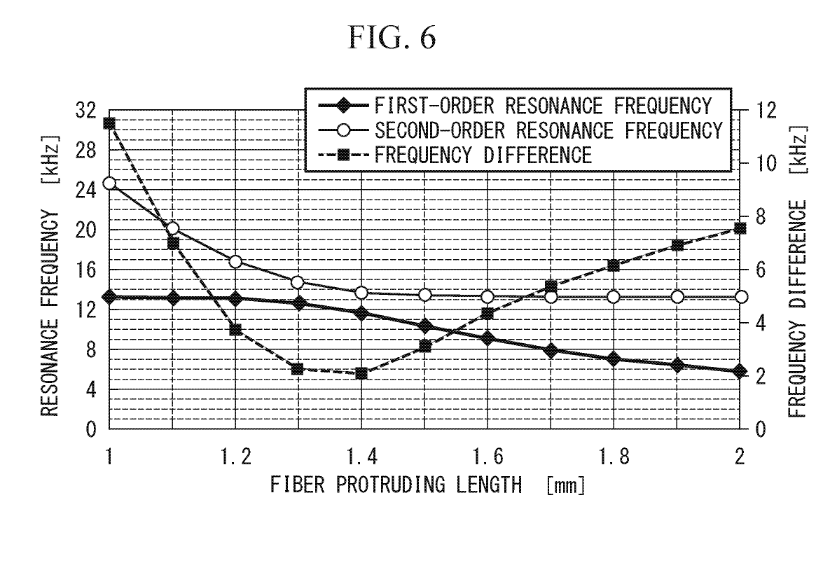

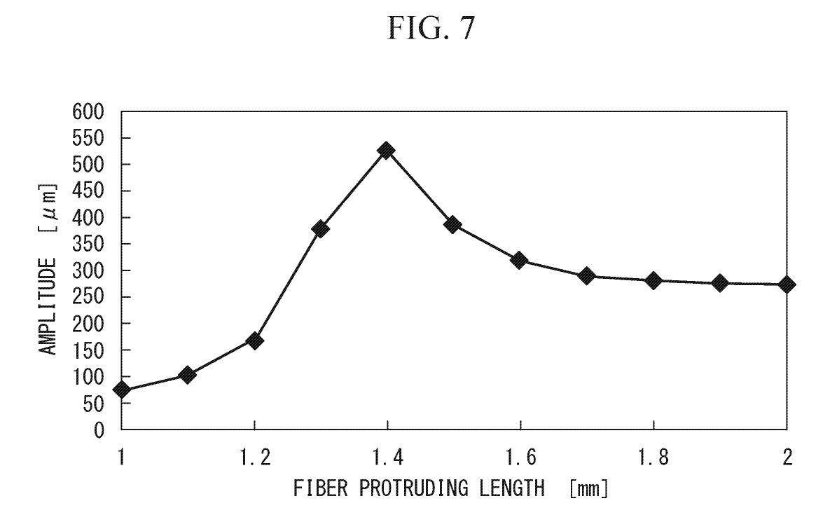

FIG. 6 shows a result of changes, obtained through simulation, in the first-order resonance frequency and second-order resonance frequency of the vibrator when the protruding length was changed from 1 mm to 2 mm. FIG. 7 shows a result of a change, obtained through simulation, in the amplitude of the distal end of the optical fiber 2 when the protruding length was changed from 1 mm to 2 mm. In the simulation in FIG. 7, the magnitude of an AC voltage applied to the piezoelectric elements was set to 45 V, and the driving frequency was set to a frequency equal to the first-order resonance frequency.

As shown in FIG. 6, the second-order resonance frequency comes closer to the first-order resonance frequency as the protruding length becomes larger starting at 1 mm, and the difference between the first-order resonance frequency and the second-order resonance frequency becomes minimum when the protruding length is 1.4 mm. On the other hand, as shown in FIG. 7, the amplitude of the distal end of the optical fiber 2 becomes maximum when the protruding length is 1.4 mm.

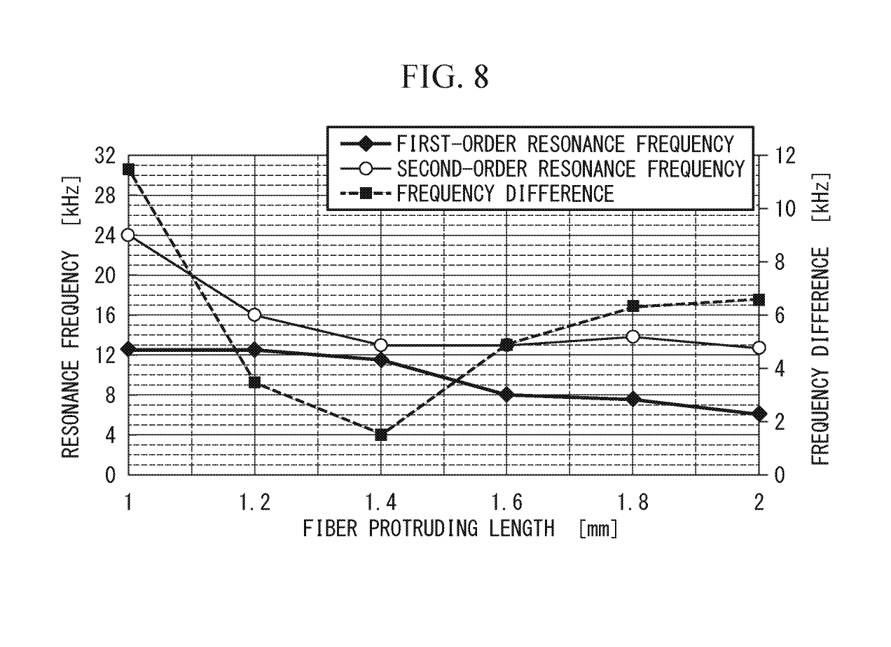

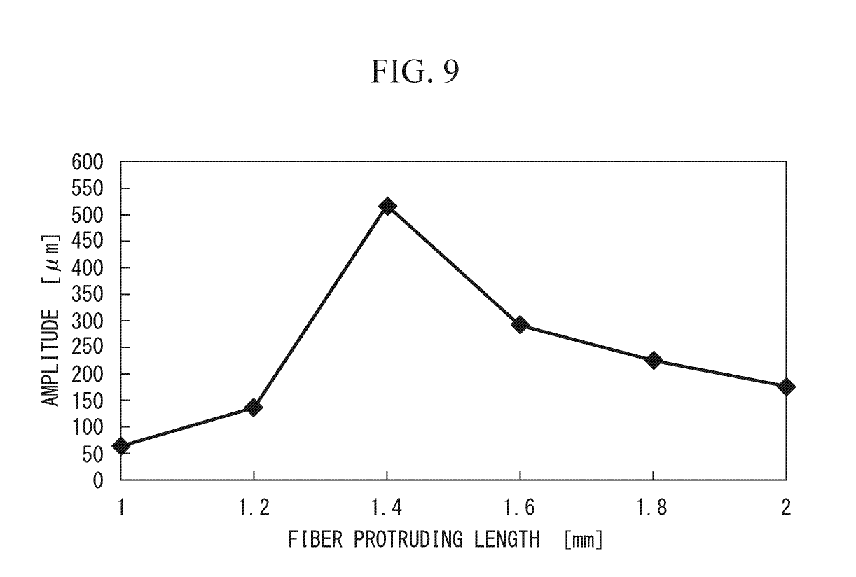

FIG. 8 shows a result of changes, obtained through experiment, in the first-order resonance frequency and second-order resonance frequency of the vibrator when the protruding length was changed from 1 mm to 2 mm. FIG. 9 shows a result of a change, obtained through an experiment, in the amplitude of the distal end of the optical fiber 2 when the protruding length was changed from 1 mm to 2 mm. In the experiment in FIG. 9, the magnitude of an AC voltage applied to the piezoelectric elements was set to 45 V, and the driving frequency was set to a frequency equal to the first-order resonance frequency.

As is recognized from FIGS. 8 and 9, the experimental results satisfactorily coincided with the simulation results in FIGS. 6 and 7.

### Example 2

In the optical scanning apparatus according to Example 2, the optical fiber diameter φ was designed so that the difference between the first-order resonance frequency and the second-order resonance frequency of the vibrator became minimum.

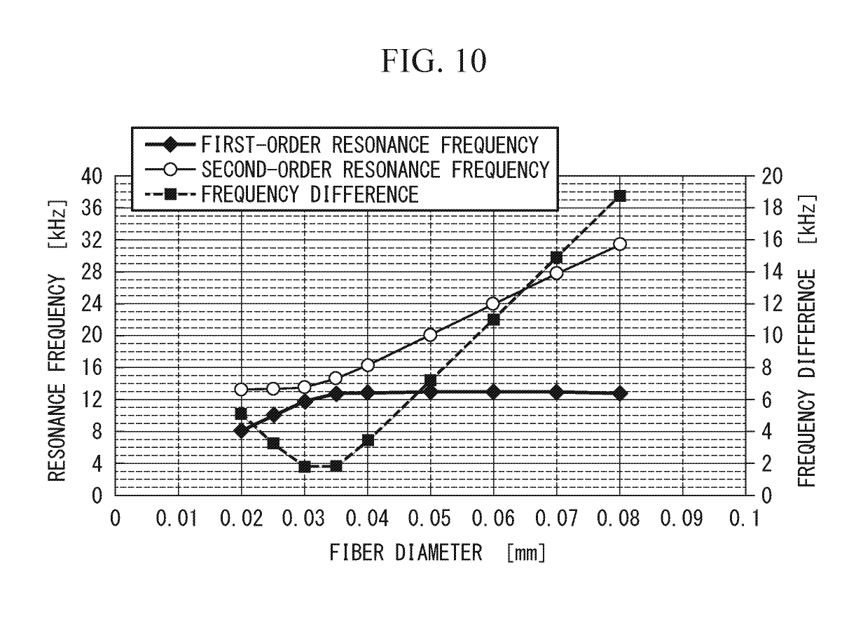

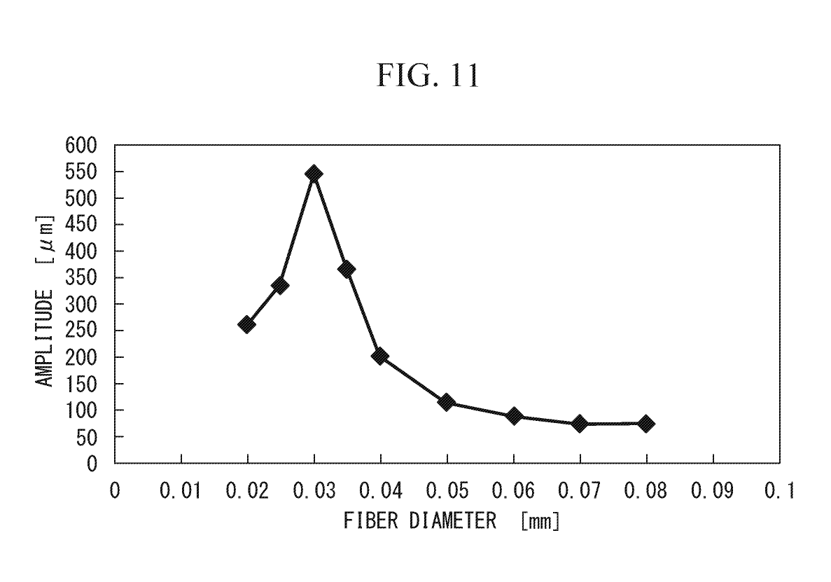

FIG. 10 shows a result of changes, obtained through simulation, in the first-order resonance frequency and second-order resonance frequency of the vibrator when the optical fiber diameter was changed from 0.02 mm to 0.08 mm. FIG. 11 shows a result of a change, obtained through simulation, in the amplitude of the distal end of the optical fiber 2 when the optical fiber diameter was changed from 0.02 mm to 0.08 mm. In the simulation in FIG. 11, the magnitude of an AC voltage applied to the piezoelectric elements was set to 45 V, and the driving frequency was set to a frequency equal to the first-order resonance frequency.

As shown in FIG. 10, the second-order resonance frequency becomes smaller as the optical fiber diameter becomes smaller starting at 0.08 mm, and the difference between the first-order resonance frequency and the second-order resonance frequency becomes minimum when the optical fiber diameter is 0.03 mm. On the other hand, as shown in FIG. 11, the amplitude of the distal end of the optical fiber 2 becomes maximum when the optical fiber diameter is 0.03 mm.

### Example 3

In the optical scanning apparatus according to Example 3, the ferrule length Lf and the piezoelectric element length Lp were designed so that the difference between the first-order resonance frequency and the second-order resonance frequency of the vibrator became minimum. The piezoelectric element length is determined according to the ferrule length. More specifically, the piezoelectric element length is designed to be about 0.2 mm smaller than the ferrule length so that both end sections of the ferrule protrude by about 0.1 mm from the piezoelectric elements in the Z direction.

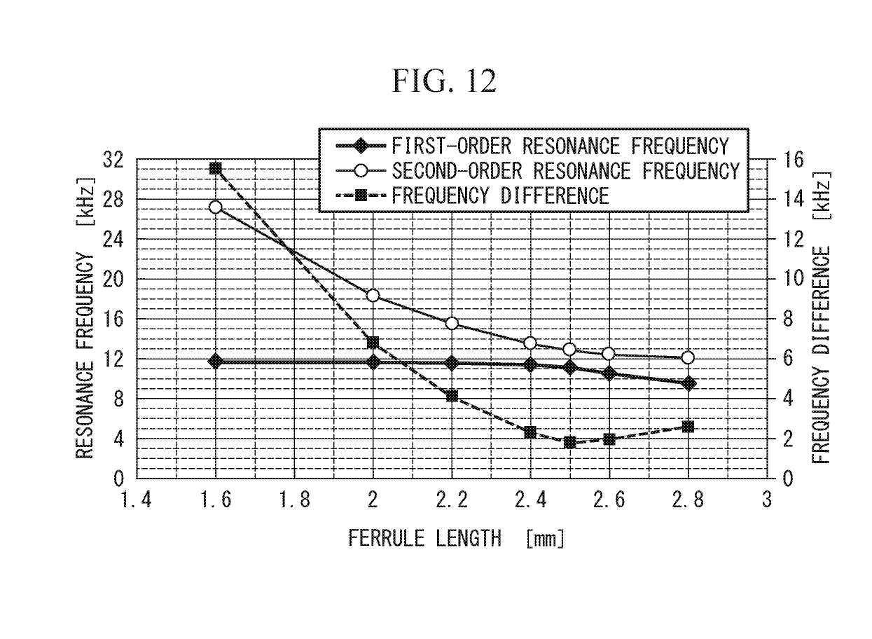

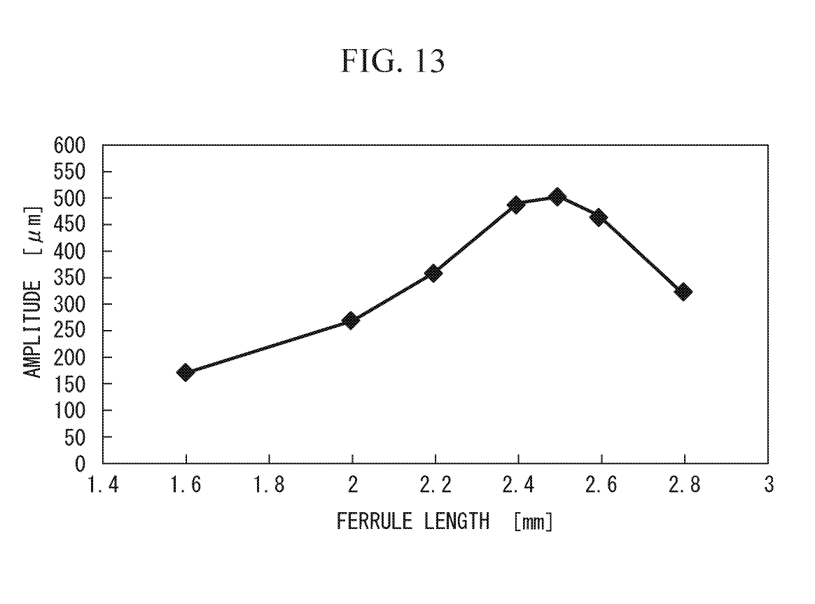

FIG. 12 shows a result of changes, obtained through simulation, in the first-order resonance frequency and second-order resonance frequency of the vibrator when the ferrule length was changed from 1.6 mm to 2.8 mm. FIG. 13 shows a result of a change, obtained through simulation, in the amplitude of the distal end of the optical fiber 2 when the ferrule length was changed from 1.6 mm to 2.8 mm. In the simulation in FIG. 13, the magnitude of an AC voltage applied to the piezoelectric elements was set to 45 V, and the driving frequency was set to a frequency equal to the first-order resonance frequency.

As shown in FIG. 12, the second-order resonance frequency becomes smaller as the ferrule length becomes larger starting at 1.6 mm, and the difference between the first-order resonance frequency and the second-order resonance frequency becomes minimum when the ferrule length is 2.5 mm. On the other hand, as shown in FIG. 13, the amplitude of the distal end of the optical fiber 2 becomes maximum when the ferrule length is 2.5 mm.

The present invention is not limited to the above-described embodiments but can be changed, as appropriate, as long as the invention does not deviate from the spirit thereof.

For example, a driving device in which a permanent magnet and electromagnetic coils are used may be employed, instead of the piezoelectric elements 4A, 4B, 4C, and 4D.

The permanent magnet is in the shape of a cylinder that is magnetized in the longitudinal direction and that has magnetic poles on both ends thereof. The optical fiber 2 is inserted into the permanent magnet such that the distal end portion, constituting the protruding section 2a, protrudes from the permanent magnet, and the permanent magnet is fixed to the outer circumferential surface of the optical fiber 2. The electromagnetic coils are provided at positions that face the respective magnetic poles of the permanent magnet in the X direction and the Y direction. As a result of AC currents (AC signals) being supplied to the electromagnetic coils from the drive control unit 50 via wiring cables, the electromagnetic coils generate magnetic fields in proximity to the magnetic poles of the permanent magnet, and the permanent magnet vibrates in the X direction and in the Y direction, thereby vibrating the protruding section 2a.

In this modification, the vibrator is composed of the permanent magnet and the optical fiber 2. Therefore, the structure parameters for governing the resonance frequency of the vibrator include: the diameter (diameter) φ of the optical fiber 2; the Z-direction length (protruding length) d of the protruding section 2a; the width, thickness, and Z-direction length of the permanent magnet; and the densities of the optical fiber 2 and the permanent magnet.

A first aspect of the present invention is an optical scanning apparatus comprising: an optical fiber for emitting illumination light from a distal end portion towards a subject; and a driving device that, when an AC signal having a driving frequency in proximity to an nth-order resonance frequency Fₙ of a vibrator including the distal end portion and a member vibrating integrally with the distal end portion is applied thereto, generates a driving force for vibrating the distal end portion of the optical fiber in a plane orthogonal to a longitudinal direction of the optical fiber, wherein the difference between the nth-order resonance frequency Fₙ and a neighboring (n±1)th-order resonance frequency F_{n±1} of the vibrator satisfies the following formula (1):

|F_{n±1}−Fₙ|≤00.25Fₙ (1).

As a result, the above-described embodiment leads to the following aspects.

According to the present invention, when an AC signal is applied to the driving device and the driving device generates a driving force, the vibrator including the distal end portion of the optical fiber vibrates, and illumination light emitted from the distal end portion of the optical fiber is scanned in the plane orthogonal to the optical axis of the illumination light. At this time, by vibrating the vibrator at a frequency in proximity to the nth-order resonance frequency, a large amplitude can be achieved due to a resonance effect.

In this case, the amplitude achieved when the vibrator is vibrated in proximity to the nth-order resonance frequency depends on the difference |F_{n±1}−Fₙ| between the nth-order resonance frequency and the (n±1)th-order resonance frequency, and the smaller the difference |F_{n±1}−Fₙ|, namely, the closer to the nth-order resonance frequency the (n±1)th-order resonance frequency comes, the larger the amplitude. Conditional formula (1) specifies the range within which the effect of increasing the amplitude by bringing the (n±1)th-order resonance frequency close to the nth-order resonance frequency can be achieved. The difference |F_{n±1}−Fₙ| is determined by the structure of the vibrator. In this manner, by decreasing the difference |F_{n±1}−Fₙ|, the amplitude of vibration of the optical fiber can be increased effectively without drawing upon an increase in input energy to the driving device.

In the above-described first aspect, the difference between the nth-order resonance frequency Fₙ and the (n±1)th-order resonance frequency F_{n±1} is preferably 3 kHz or less.

In this manner, the effect of increasing the amplitude by bringing the (n±1)th-order resonance frequency close to the nth-order resonance frequency can be further enhanced.

In the above-described first aspect, the driving frequency is preferably a frequency in proximity to a third-order or lower resonance frequency of the vibrator (namely, n≤3 in conditional formula (1)).

In order to increase the amplitude of the vibrator, it is preferable that the resonance of a lower-order resonance frequency be used. By vibrating the vibrator at a frequency in proximity to the third-order or lower resonance frequency, an amplitude of the distal end of a practical optical fiber can be achieved.

A second aspect of the present invention is a method for assembling and adjusting an optical scanning apparatus including: an optical fiber for emitting illumination light from a distal end portion towards a subject; and a driving device that, when an AC signal having a driving frequency in proximity to an nth-order resonance frequency Fₙ of a vibrator including the distal end portion and a member vibrating integrally with the distal end portion is applied thereto, generates a driving force for vibrating the distal end portion of the optical fiber in a plane orthogonal to a longitudinal direction of the optical fiber, the method comprising: an assembly step of assembling the optical fiber and the driving device, wherein a structure parameter for governing a resonance frequency of the vibrator is adjusted such that the difference between the nth-order resonance frequency Fₙ and a neighboring (n±1)th-order resonance frequency F_{n±1} of the vibrator satisfies the following formula (1):

|F_{n±1}−Fₙ|≤0.25Fₙ (1)

In the above-described second aspect, the structure parameter adjusted in the assembly step may be at least one of the length of the distal end portion of the optical fiber and the length of a ferrule for supporting the distal end portion.

In this manner, the difference |F_{n±1}−Fₙ| in the resonance frequency of the vibrator can be adjusted merely by position adjustment of the optical fiber and the ferrule without involving processing of the member.

The present invention affords an advantage in that the amplitude of vibration of an optical fiber can be increased effectively without increasing input energy.

### REFERENCE SIGNS LIST

1 Optical scanning apparatus
2 Optical fiber
2a Protruding section (distal end portion)
3 Ferrule
4A, 4B, 4C, 4D Piezoelectric element (driving device)

1. An optical scanning apparatus comprising:
an optical fiber that is configured to emit light from a distal end portion towards a subject; and
a driving device that, when an AC signal having a driving frequency in proximity to an nth-order resonance frequency Fₙ of a vibrator including the distal end portion and a member vibrating integrally with the distal end portion is applied thereto, generates a driving force for vibrating the distal end portion of the optical fiber in a plane orthogonal to a longitudinal direction of the optical fiber,
wherein a difference between the nth-order resonance frequency Fₙ and a neighboring (n±1)th-order resonance frequency F_{n±1} of the vibrator satisfies the following formula (1):

|F_{n±1}−Fₙ|≤0.25Fₙ (1).

2. The optical scanning apparatus according to claim 1, wherein the difference between the nth-order resonance frequency Fₙ and the (n±1)th-order resonance frequency F_{n±1} is 3 kHz or less.

3. The optical scanning apparatus according to claim 1, wherein the driving frequency is a frequency in proximity to a third-order or lower resonance frequency of the vibrator.

4. A method for assembling and adjusting an optical scanning apparatus including:
an optical fiber for emitting illumination light from a distal end portion towards a subject; and
a driving device that, when an AC signal having a driving frequency in proximity to an nth-order resonance frequency Fₙ of a vibrator including the distal end portion and a member vibrating integrally with the distal end portion is applied thereto, generates a driving force for vibrating the distal end portion of the optical fiber in a plane orthogonal to a longitudinal direction of the optical fiber, the method comprising:
assembling the optical fiber and the driving device, wherein a structure parameter for governing a resonance frequency of the vibrator is adjusted such that a difference between the nth-order resonance frequency Fₙ and a neighboring (n±1)th-order resonance frequency F_{n±1} of the vibrator satisfies the following formula (1):

|F_{n±1}−Fₙ|≤0.25Fₙ (1).

5. The method for assembling and adjusting an optical scanning apparatus according to claim 4, wherein the adjusted structure parameter is at least one of the length of the distal end portion of the optical fiber and the length of a ferrule for supporting the distal end portion.
